(19) United States
(12) Patent Application Publication
(10) Pub. No.: US 2026/0092814 A1
(43) Pub. Date: Apr. 2, 2026

(54) INFRARED DETECTOR

(71) Applicant: ORIOMA, MOIRANS (FR)

(72) Inventor: Philippe ECREMENT, MOIRANS (FR)

(21) Appl. No.: 19/483,060

(22) PCT Filed: Jun. 13, 2023
(86) PCT No.: PCT/EP2023/065745

§ 371 Date: Nov. 10, 2025

(30) Foreign Application Priority Data
Jun. 20, 2022 (FR) FR2206032

(51) Int. Cl. G01J 5/02; G01J 5/04

(52) U.S. Cl. CPC G01J 5/028; G01J 5/04

(57) ABSTRACT

The present description relates to an infrared detector (100) comprising:—a housing (110) having at least a first substantially planar face (110B);—at least one infrared sensor (102) mounted in or on the first face;—at least one energy collector in the form of a panel (120) having the shape of at least one side face of a truncated cone and masking all or part of at least one second face (110C) of the housing different from the first face.

### TECHNICAL FIELD

The present description relates generally to infrared detectors and in particular, to infrared detectors comprising at least one infrared sensor integrated into a housing.

### PRIOR ART

Infrared sensors, or infrared imagers, are known. For example, they may be resistive sensors of the bolometer type.

One or more infrared sensors may be integrated into a housing, for example to form an infrared detector. An infrared detector may be used for applications such as the Internet of Things (IoT), smart building and remote surveillance. For example, an infrared detector can be fixed to the ceiling of a room.

The housing can also integrate a data processing unit of the infrared sensor(s) and/or a wireless communication unit, and both can be energy consumers.

In some applications, an infrared detector that is the most autonomous and/or the most energy-efficient as possible, and preferably wireless and without a battery to change, may be sought. For example, the housing of the detector may be equipped with photovoltaic cells.

In some applications, an infrared detector that is the most discreet and the smallest as possible may be sought, for example for motion or intrusion detection in a building.

However, seeking the smallest as possible infrared detector may conflict with its autonomy seeking, for example because the area for arranging photovoltaic cells is all the more reduced as the detector, and therefore the housing, is small.

### SUMMARY OF THE INVENTION

There is a need for an autonomous infrared detector whose size can be reduced without impacting its autonomy.

In particular, it would be desirable to have an autonomous infrared detector having a processing unit and/or a wireless communication unit and whose size can be reduced without impacting its autonomy.

One embodiment overcomes all or some of the disadvantages of known infrared detectors.

One embodiment provides an infrared detector comprising:
a housing having at least one substantially planar first face;
at least one infrared sensor mounted in or on the first face;
at least one energy collector in the form of a panel having the shape of at least one side face of a truncated cone and masking all or part of at least one second face of the housing different from the first face.

One embodiment provides an infrared detector comprising:
a housing having a longitudinal direction and having at least one substantially planar first face;
at least one energy collector in the form of a panel having the shape of at least one side face of a truncated cone and masking all or part of at least one second face of the housing different from the first face;
at least one infrared sensor;
   the generatrix of the truncated cone being in the longitudinal direction of the housing, the at least one infrared sensor being positioned at a base of the truncated cone.

For example, the at least one infrared sensor is positioned at the truncation of the truncated cone.

According to one embodiment, the housing comprises a first part in the shape of a first truncated cone, and the at least one energy collector in the form of a panel comprises at least one energy collector element assembled, for example fixed, on said first part of the housing, the at least one side face corresponding to all or part of the at least one second face of the housing. Preferably, the at least one infrared sensor is mounted on or in the first face of the housing.

According to one embodiment, the housing comprises a second part in the shape of a second truncated cone similar to the first truncated cone and whose main base is assembled to the main base of said first truncated cone, and the at least one energy collector in the form of a panel comprises at least one energy collector element assembled, for example fixed, on the first housing part and at least one other energy collector element assembled, for example fixed, on the second housing part.

According to one embodiment, the detector comprises a fixing element adapted to fix the at least one energy collector element to the housing, for example a groove formed in said housing.

According to one embodiment, at least one of the at least one second face is oriented at an angle relative to the first face, said angle being greater than 0° and less than 180°.

According to one embodiment, the at least one energy collector in the form of a panel is positioned at a distance from the housing, and the at least one side face is offset from the at least one second face of the housing.

According to one embodiment, the detector comprises a support structure adapted to position the at least one energy collector in the form of a panel at a distance from the at least one second face of the housing, said support structure being secured to said housing.

Preferably, the support structure has a frustoconical shape, the at least one infrared sensor being mounted either on or in the first face of the housing, or on or in a base of the support structure.

According to a particular embodiment, the support structure has fixing tabs adapted to receive and hold the at least one energy collector in the form of a panel.

According to one embodiment, the housing has a substantially parallelepiped shape, for example cubic, or a substantially cylindrical shape, for example circular cylindrical.

According to one embodiment, the at least one energy collector in the form of a panel surrounds the housing at 360 degrees.

According to one embodiment, the at least one energy collector in the form of a panel is oriented so as to optimize light capture, for example so as to optimize the angle of incidence of light rays on said at least one energy collector in the form of a panel.

According to one embodiment, the truncated cone is a truncated circular cone or a truncated pyramidal cone.

According to one embodiment, the housing further comprises:
a processing unit connected to the at least one infrared sensor;
a wireless communication unit connected to the processing unit; and/or
an energy storage unit connected to the at least one energy collector in the form of a panel.

Preferably, the processing unit, the wireless communication unit and/or the energy storage unit are positioned in the housing.

According to one embodiment, the detector further comprises a wireless communication antenna, for example mounted on the first face.

According to one embodiment, the at least one energy collector in the form of a panel has a single energy collector element, for example in the form of a flexible film.

According to one embodiment, the at least one energy collector in the form of a panel has several energy collector elements assembled to each other in series and/or in parallel.

According to one embodiment, the at least one energy collector in the form of a panel comprises, for example, at least one photovoltaic panel.

According to one embodiment, the at least one energy collector element is a photovoltaic element.

### BRIEF DESCRIPTION OF THE DRAWINGS

The foregoing features and advantages, as well as others, will be described in detail in the following description of particular embodiments given on a non-limiting basis with reference to the accompanying drawings, in which:

FIG. 1A and FIG. 1B are perspective schematic views of an infrared detector according to a first embodiment;

FIG. 2 is a perspective schematic view of an infrared detector according to a second embodiment;

FIG. 3 is a perspective schematic view of an infrared detector according to a third embodiment;

FIG. 4 is a perspective schematic view of an infrared detector according to a fourth embodiment;

FIG. 5 illustrates a first variant of the infrared detector of FIG. 4;

FIG. 6 illustrates a second variant of the infrared detector of FIG. 4; and

FIG. 7 illustrates an example of an implementation of the infrared detector of FIG. 4.

### DESCRIPTION OF THE EMBODIMENTS

Same elements have been designated by same references in the various figures. In particular, the structural and/or functional elements that are common among the various embodiments may have the same references and may have identical structural, dimensional and material properties.

For the sake of clarity, only the steps and elements useful for an understanding of the described embodiments have been illustrated and are described in detail. In particular, details of the wireless processing and communication units of the infrared sensors and details of the energy storage units of the photovoltaic panels (energy collectors in the form of panels) are not given, as they are within the skill of the person skilled in the art.

Unless indicated otherwise, when reference is made to two elements connected together, this signifies a direct connection without any intermediate elements other than conductors, and when reference is made to two elements coupled together, this signifies that these two elements can be connected or coupled via one or more other elements.

In the following description, when reference is made to absolute position qualifiers, such as the terms “front”, “rear”, “top”, “bottom”, “left”, “right”, etc., or to relative qualifiers such as the terms “above”, “below”, “upper”, “lower”, etc., or to orientation qualifiers such as the terms “horizontal”, “vertical”, etc., unless indicated otherwise, reference is made to the orientation of the figures or to an infrared detector in a normal position of use.

When reference is made to a cone, reference is made to the general definition, i.e., for a conical surface, a surface formed by a generatrix, passing through a fixed point, called the apex, and a variable point describing a curve, called the directrix, and, for a solid cone, the solid bounded by the conical surface. The generatrix can be straight, or it can be curved, so as to form a convex or concave cone. A cone can, for example, be a right circular cone, or cone of revolution, or a pyramidal cone. When reference is made to a truncated cone, reference is made to the truncation of the apex of the cone, which then has a secondary base corresponding to the truncation, in addition to the main base opposite the truncated apex. A side face of the cone corresponds to a face developed by the generatrix. A cone of revolution comprises a side face which, when developed on a plane, takes the form of a sector of a circle, or of a sector of a ring for a truncated cone of revolution. A pyramidal cone comprises several side faces, each of which having a triangle shape, or a trapezoid shape for a truncated pyramidal cone.

When reference is made to a photovoltaic panel, or more generally to an energy collector in the form of a panel, “having the shape of a side face” of a truncated cone, it should be understood that the panel follows the shape of a side face, but not necessarily the entire side face, for example, it may correspond to a portion of the side face of the truncated cone. According to one example, for a truncated cone of revolution, the panel may have the shape of a portion of the side face. According to another example, for a truncated pyramidal cone, the panel may have the dimensions of one or more side faces, or of a portion of one or more side faces.

Unless indicated otherwise, the terms “about”, “approximately”, “substantially” and “in the order of” mean within 10%, preferably within 5%.

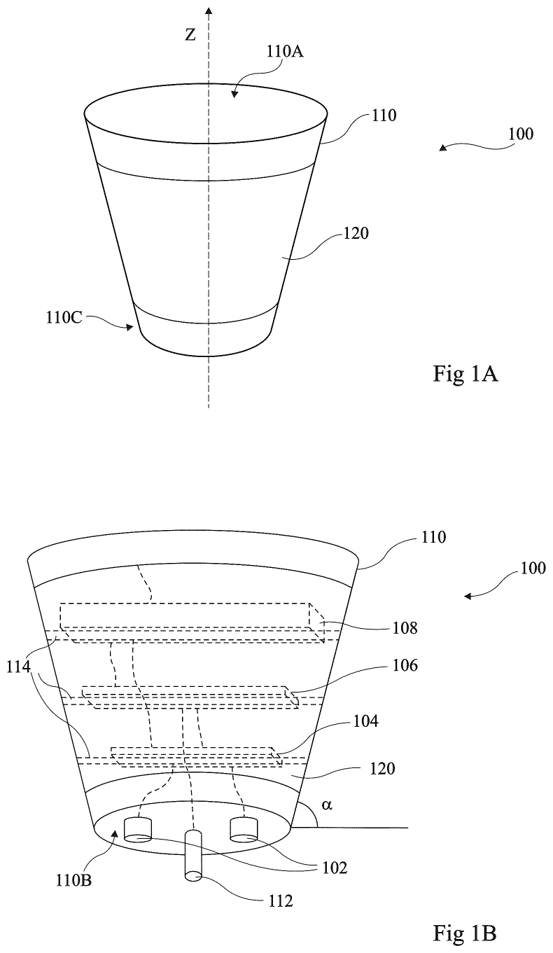

FIGS. 1A and 1B are perspective schematic views of an infrared detector 100 according to a first embodiment.

The infrared detector 100 comprises a housing 110 in the shape of a truncated cone of revolution. The generatrix of the truncated cone of revolution is in the longitudinal direction Z of the housing 110. In the truncation of the cone, forming a substantially planar secondary base 110B (first face), two infrared sensors 102 and a radio antenna 112 are mounted. The truncated cone has a substantially planar main base 110A and a side face 110C connecting the main base and the secondary base.

The frustoconical housing 110 is, for example, to be installed on the ceiling of a room via its main base 110A (fixing means not illustrated). When installed, the truncated cone is inverted (truncation with the infrared sensors below, main base above), as illustrated in FIGS. 1A and 1B. As a variant, the frustoconical housing 110 may be installed on a wall of a room, via its main base 110A.

A photovoltaic panel 120 (energy collector in the form of a panel), for example a photovoltaic panel in the form of a flexible film, is mounted on at least a portion of the side face 110C. The photovoltaic panel may be a panel comprising a single photovoltaic element (energy collector elements), as illustrated (continuous panel), assembled on the entire circumference of the side face, but not necessarily over the entire height.

According to one variant of implementation, the panel may comprise several photovoltaic elements (energy collector elements) connected to each other in series and/or in parallel. For example, a photovoltaic element may be a flexible element, for example in the form of a flexible film, or may be a rigid element with a non-planar shape. The elements may be assembled on the side face so as to cover all or part of the circumference and/or of the height of said side face. Preferably, the photovoltaic elements are arranged so as to minimize the influence of shadows or of lighting differences on the different faces of the housing.

The photovoltaic panel, whether consisting of one or more elements, can be fixed to the housing via grooves formed in said housing, and more particularly in the faces on which the panel is to be assembled, or via other suitable fixing means.

The shape of the housing allows, by positioning the photovoltaic panel on the side face of the housing, which is oblique, to optimize the angle of incidence of the light rays on the panel, and thus to optimize the energy production by said panel, while taking into account geometric and functional constraints of the housing. In particular, the housing must have a first substantially planar face in which at least one infrared sensor is mounted, and which must not be covered by a photovoltaic panel, among other things so as not to distort the measurements.

The angle α of the side face 110C relative to the secondary base 110B can be optimized so that said side face corresponds to, or approximates, the normal of the angle of incidence of the light rays on the photovoltaic panel depending on the configuration in which the infrared detector is to be used, for example depending on the location of the detector in a room and/or on the configuration of the artificial and/or natural light sources recoverable in the room, for example via a window (in emission and/or reflection). Preferably, the angle α is greater than 0° and less than 180°. For example, the angle α is equal to 40°, which in particular allow to optimize the recovery of natural light when the infrared detector 100 is fixed to the ceiling of a room and the windows of the room do not extend up to the ceiling.

According to another example, the detector is positioned depending on the location of artificial and/or natural light sources in a room, for example approximatively in the middle of a set of light sources surrounding it.

The shape of the housing may also be different, such as the shapes described below in the other examples, without these being limiting.

Inside the housing, the following components are mounted, for example via racks 114 fixed in the housing:
a processing unit 104 connected to each infrared sensor 102;
a wireless communication unit 106 connected on the one hand to the radio antenna 112 and on the other hand to the processing unit 104; and/or
an energy storage unit 108 connected on the one hand to the photovoltaic panel 120 and on the other hand to each unit to power it.

The processing unit 104 is adapted to process the data collected by each infrared sensor 102. The processing unit can be configured to determine, from the collected data, information about a temperature, a number of people and a carbon dioxide (CO₂) level and/or a brightness level in a room, etc. The information provided by the processing unit can be transmitted via a wireless link (radio link) to a supervision unit (not illustrated) at a distance from the detector. The supervision unit can be connected to one or more other detectors similar to the detector 100, and/or to one or more other detectors different from the detector 100. The processing unit 104 comprises, for example, an electronic card.

The CO₂ level may, for example, be determined depending on the number of people detected in a room by the infrared sensors and on the occupancy duration by the person(s) in the room. The temperature can, for example, be used to detect a hot point, potentially dangerous, in a room. The brightness level can be used, for example, to regulate the intensity of lighting in a room.

According to one example, radio communications emitted, or even received, by the detector comply with the LoRaWAN radio protocol. LoRaWAN is the acronym for “Long Range Wide-Area Network”. LoRaWAN enables long-range communications at low cost and low power consumption. The wireless communication unit 106 may then comprise a communication electronic card operating on LoRa radio technology. According to another example, radio communications may comply with other technologies such as Bluetooth™. The wireless communication unit 106 is then, for example, a communication electronic card operating on Bluetooth™ technology.

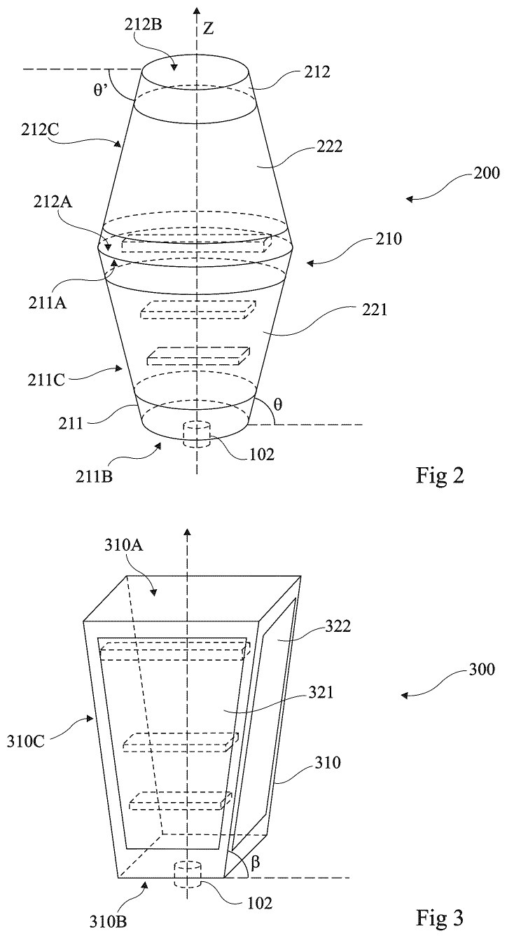

FIG. 2 is a perspective schematic view of an infrared detector 200 according to a second embodiment, which differs from the first embodiment in the shape of the housing 210. The housing 210 corresponds to an assembly of two substantially identical truncated cones of revolution, a first cone of revolution 211 (lower cone) and a second cone of revolution 212 (upper cone). The generatrices of the truncated cones of revolution are in the longitudinal direction Z of the housing 210. The two truncated cones are assembled by their main bases 211A, 212A. At least one infrared sensor 120 is mounted in the truncation 211B of the lower cone 211, corresponding to the first face.

A photovoltaic panel 221, 222, for example a photovoltaic panel in the form of a flexible film, is mounted on at least a portion of the side face 211C, 212C of each truncated cone 211, 212. As illustrated, each photovoltaic panel may be a panel comprising a single photovoltaic element (continuous panel) on each side face, assembled on the entire circumference of the side face, but not necessarily over the entire height. According to one variant of implementation, the panel may comprise several photovoltaic elements assembled to each other in series and/or in parallel on each side face. For example, a photovoltaic element may be a flexible element, for example in the form of a flexible film, or may be a rigid element with a non-planar shape. The elements may be assembled on each side face so as to cover all or part of the circumference and/or of the height of said side face.

This shape of the housing makes it possible to increase the surface area of photovoltaic panels that can be assembled on said housing, and thus potentially to increase energy production, but it also makes it possible to take into account other angles of incidence of light rays on the side faces.

The double frustoconical housing 210 can be to be installed on a ceiling of a room, for example, via the truncation 212B of the upper cone 212 (fixing means not illustrated). As a variant, the housing 210 can be to be installed on a wall of a room via the truncation 212B.

The angle θ of the side face 211C relative to the truncation 211B of the lower cone 211 may be within the same range as the angle α given in relation to FIGS. 1A and 1B, as may the angle θ′ of the side face 212C relative to the truncation 212B of the upper cone 212. The angles θ and θ′ may be equal or different.

The other features of the detector 200 may be similar to those of the detector 100 described in relation to FIGS. 1A and 1B, for example:
the units mounted inside the housing, for example via racks;
the presence of several infrared sensors; and/or
the presence of an antenna.

FIG. 3 is a perspective schematic view of an infrared detector 300 according to a third embodiment, which differs from the first embodiment in the shape of the housing 310, which has a truncated pyramidal cone shape. The generatrix of the truncated pyramidal cone is in the longitudinal direction Z of the housing 310.

The angle β of each side face 310C relative to the truncation (secondary base) 310B of the truncated pyramidal cone is preferably greater than 0° and less than 180°. For example, the angle β is equal to 40°.

The photovoltaic panel is represented as an assembly of several photovoltaic elements 321, 322, for example a photovoltaic element fixed on some side faces 310C, or even on all the side faces, of the truncated pyramidal cone. In order not to complicate FIG. 3, photovoltaic elements are illustrated on only two of the four side faces, but there may be elements on three side faces or on all the four side faces, or even on only one. In addition, each photovoltaic element may cover an entire side face, or only a portion of said side face. These elements may be flexible elements or rigid elements, for example with a substantially planar shape.

Alternatively, it is possible to assemble a photovoltaic panel comprising a single element (continuous panel) on several side faces of the truncated pyramidal cone, for example in the form of a photovoltaic film, provided that the minimum radius of curvature allowed by the photovoltaic film permits it.

A truncated pyramidal cone with four faces has been illustrated, but a truncated pyramidal cone with three faces, or even more than four faces, could be considered.

As a variant, two truncated pyramidal cones can be assembled in the same way as the two o truncated cones of revolution of FIG. 2.

The other features of the detector 300 may be similar to those of the detector 100 described in relation to FIGS. 1A and 1B, for example:
the units mounted inside the housing, for example via racks;
the presence of one or more infrared sensors 102 at the secondary base 310B (truncation) of the housing; and/or
the presence of an antenna.

The housing 310 is, for example, to be installed on a ceiling of a room, via its main base 310A (fixing means not illustrated). When installed, the truncated cone is inverted (truncation with the infrared sensor(s) below, main base above), as illustrated in FIG. 3. As a variant, the housing 310 may be installed on a wall of a room, via its main base 310A.

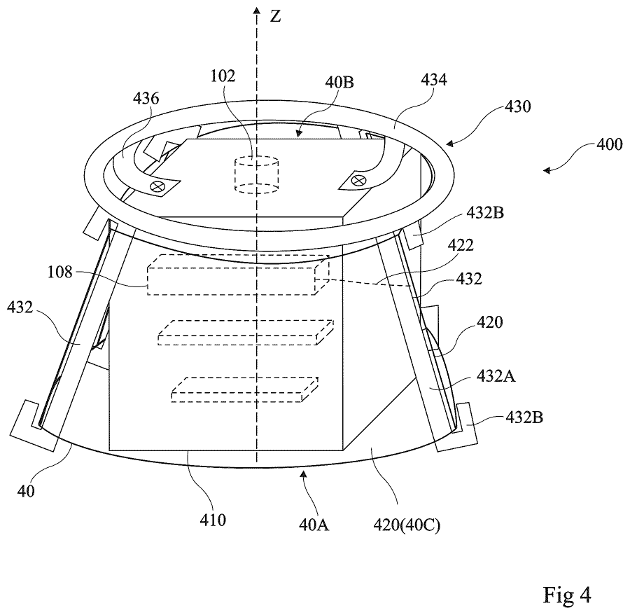

FIG. 4 is a perspective schematic view of an infrared detector 400 according to a fourth embodiment, which differs from the first, second and third embodiments in that the photovoltaic panel 420 is not assembled on the housing 410. In the embodiment illustrated, the photovoltaic panel 420 is positioned at a distance from the side faces of the housing 410 of the infrared detector 400 so as to mask them, and has a shape of a substantially circular truncated cone 40. For example, the photovoltaic panel 420 corresponds to all or part of the side face 40C of the truncated cone. The generatrix of the truncated cone 40 is substantially in the longitudinal direction Z of the housing 410.

More particularly, the detector 400 comprises a support structure 430 adapted to position and hold in place the photovoltaic panel 420 (whether it consists of one or more elements). The support structure 430 is preferably a lightweight structure. The support structure 430 may also have a shape of a truncated cone (frustoconical shape) whose generatrix is substantially in the longitudinal direction Z of the housing 410.

The support structure 430 illustrated has fixing tabs 432 into which the photovoltaic panel 420 can be inserted. For example, each fixing tab comprises a substantially straight bar 432A, each end 432B of which has the shape of a hook so that the photovoltaic panel 420 can be inserted and held in place. The shape of the fixing tabs, in particular the shape of the bars, makes it possible to define, for example, the shape, the size, and/or the curvature of the photovoltaic panel associated with the housing. The fixing tabs can be connected to a ring 434 or any other suitable basement, said basement being able to be fixed to the housing by any suitable means, for example by means of lugs 436 fixed to said housing by screwing, or by means of plug-in feet.

Other support structures are possible, especially depending on the shape and the dimensions of the housing, on the shape and the dimensions of the photovoltaic panel and/or on the positioning of the photovoltaic panel relative to the housing.

The photovoltaic panel 420 is located near the housing 410 and masks at least one face of said housing. It is not necessary for it to surround the housing. Thus, other embodiments are feasible.

The photovoltaic panel 420 is connected to the housing 410 to transfer the recovered energy to it, for example, the photovoltaic panel is connected to an energy storage unit 108 positioned in the housing. An electrical connection 422, for example an electrical cable, may be provided between the photovoltaic panel 420 and the housing 410, for example to the energy storage unit 108.

Preferably, the photovoltaic panel 420 does not cover the infrared sensor(s) 102, and one of which is illustrated in FIG. 4 at the truncation 40B, or secondary base, of the truncated cone 40.

The infrared detector 400 is, for example, to be installed on a ceiling of a room, at the main base 40A of the truncated cone 40 (fixing means not illustrated). The infrared detector 400 is illustrated in FIG. 4 with its orientation reversed (by about 180°) from its orientation when installed on the ceiling of a room, with the secondary base 40B with the infrared sensor(s) 102 to be oriented toward the floor and the main base 40A toward the ceiling. As a variant, the infrared detector 400 may be installed on a wall of a room. The infrared detector 400 is illustrated in FIG. 4 rotated by about 90° from its orientation when installed on a wall of a room.

FIG. 4 illustrates a panel comprising a single element, for example, an element in the form of a flexible film. Alternatively, the panel may comprise several photovoltaic elements assembled to each other in series and/or in parallel and held in place in the support structure. The elements may be flexible or rigid, preferably with non-planar shapes.

The other features of the detector 400 may be similar to those of the detector 100 described in relation to FIGS. 1A and 1B, for example:
the units mounted inside the housing, for example via racks;
the presence of one or more infrared sensors; and/or
the presence of an antenna.

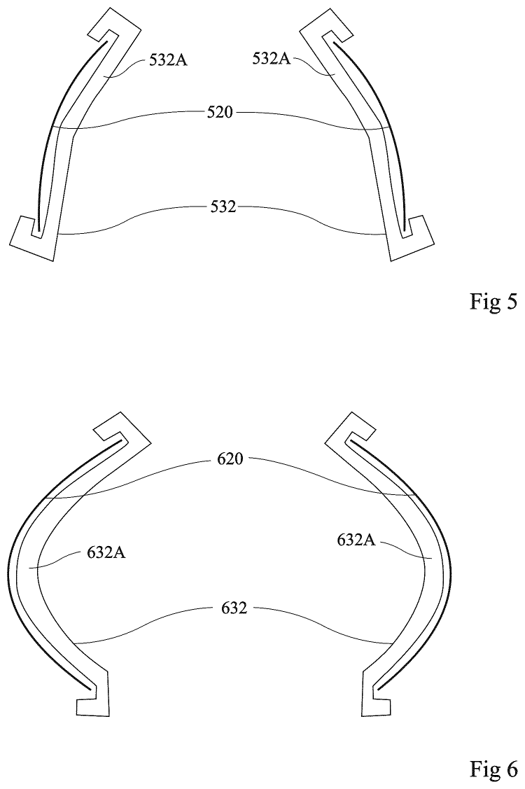

This fourth embodiment provides several advantages over the previous embodiments, among which:
several shapes of support structure and associated photovoltaic panel are possible, for example to adapt to different configurations of use of the infrared detector;
the support structure can be manufactured via a 3D printing technology, allowing various shapes of structure to be produced at reduced cost;
the housing can have a simple shape, for example cylindrical or parallelepiped, or even cubic, allowing a manufacturing at reduced cost;
the photovoltaic panel can have a surface area much larger than the surface area of the housing;
the shape given to the photovoltaic panel can be adjustable, for example by adapting the shape of the support structure, as illustrated in FIGS. 5 and 6.

FIG. 5 illustrates a first variant of tab 532 of the support structure whose the bar 532A is no longer completely straight but has a slight bending in its center, giving the photovoltaic panel 520 a more rounded shape than in FIG. 4.

FIG. 6 illustrates a second variant of tab 632 of the support structure whose the bar 632A is no longer at all straight, but is bent, giving the photovoltaic panel 620 an also curved shape.

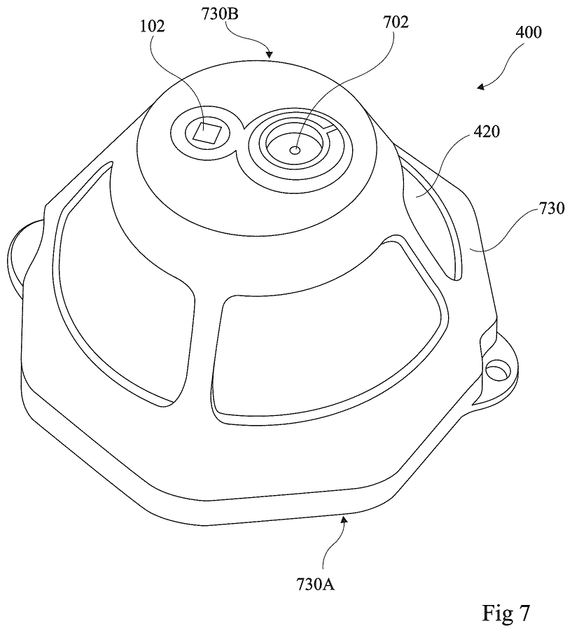

FIG. 7 illustrates an example of implementation of the infrared detector 400 of FIG. 4, in which the photovoltaic panel 420 is held by a support structure 730 having a shape of a truncated cone. The photovoltaic panel 420 is positioned at 360° around the housing (not illustrated in FIG. 7 because it is hidden by the photovoltaic panel).

The infrared aensor 102 is positioned at the truncation 430B, or secondary base, of the support structure 430 in the shape of a truncated cone. The infrared sensor 102 could be installed in the support structure 430. As a variant, the infrared sensor 102 could be installed in the housing and pass through the support structure 430 to be flush with the truncation 430B.

The infrared detector 400 illustrated in FIG. 7 further comprises a second infrared sensor 702. Similar to the infrared sensor 102, the second infrared sensor 702 can be installed in the support structure 430, or in the housing and pass through the support structure 430 to be flush with the truncation 430B.

The infrared detector 400 illustrated in FIG. 7 is, for example, to be installed on a ceiling of a room, at the main base 730A of the support structure 730 (fixing means not illustrated). The infrared detector 400 of FIG. 4 is then illustrated with a reversed orientation (at about 180°), with the secondary base 730B with the infrared sensor(s) 102 to be oriented toward the floor and the main base 730A toward the ceiling. As a variant, the infrared detector 400 may be installed on a wall of a room. The infrared detector 400 illustrated in FIG. 7 is then illustrated rotated at about 90° from its orientation when installed.

The photovoltaic panel 420 is illustrated in FIG. 7 as having a regular height all around the housing in the support structure 730 in the shape of a truncated cone. This is not limiting and, as a variant, the photovoltaic panel may have a non-regular height around the housing, more generally a non-regular shape and/or dimensions around the housing.

The photovoltaic panel 420 is illustrated as comprising a single photovoltaic element. As a variant, the photovoltaic panel 420 may be composed of several photovoltaic elements assembled in the support structure 730 in the shape of a truncated cone. The photovoltaic elements may be of equivalent sizes, or may be of different sizes, for example of different heights.

Furthermore, the photovoltaic panel may be positioned regularly and continuously around the housing at 360°, as illustrated in FIG. 7, but this is not limiting. As a variant, the photovoltaic panel, consisting of one or more photovoltaic elements, may be positioned irregularly and/or discontinuously around the housing at 360°. It is reminded that when reference is made to a photovoltaic panel “having the shape of a side face” of a truncated cone, it should be understood that the photovoltaic panel follows the shape of a side face, but not necessarily the entire side face; for example, it may correspond to a portion of the side face of the truncated cone.

An infrared detector according to one embodiment can be used for applications such as the Internet of Things (IoT), smart building, remote surveillance, etc.

Various embodiments and variants have been described. Those skilled in the art will understand that certain features of these various embodiments and variants could be combined, and other variants will be apparent to those skilled in the art. In particular, although the embodiments are described with photovoltaic panels or elements, the energy collector in the form of a panel may be in the form of a thermal panel or other energy collector panel, provided that similar problems arise.

In addition, the embodiments show photovoltaic panels or elements having the shape of at least one side face of a truncated cone, the truncated cone having a straight generatrix. As a variant, at least one photovoltaic panel or element may have the shape of at least one side face of a truncated cone whose generatrix is curved, so as to form a curved, for example concave, truncated cone. The concave shape may be calculated to maximize the number of light rays oriented along lines normal to the surface of the photovoltaic panel (i.e., perpendicular to the tangent or to the point of arrival of the light rays on the panel).

Finally, the practical implementation of the described embodiments and variants is within the reach of a person skilled in the art based on the functional indications given above.

1. An infrared detector comprising:
a housing having a longitudinal direction and having at least one substantially planar first face;
at least one energy collector in the form of a panel having the shape of at least one side face of a truncated cone and masking all or part of at least one second face of the housing different from the first face;
at least one infrared sensor;
the generatrix of the truncated cone being in the longitudinal direction of the housing, and the at least one infrared sensor being positioned at a base of the truncated cone.

2. The infrared detector according to claim 1, wherein the housing comprises a first part in the shape of a first truncated cone, the at least one infrared sensor is mounted on or in the first face of the housing, and the at least one energy collector in the form of a panel comprises at least one energy collector element assembled, for example fixed, on said first housing part, the at least one side face corresponding to all or part of the at least one second face of the housing.

3. The infrared detector according to claim 2, wherein the housing comprises a second part in the shape of a second truncated cone similar to the first truncated cone and whose main base is assembled to the main base of said first truncated cone, and the at least one energy collector in the form of a panel comprises at least one energy collector element assembled, for example fixed, on the first housing part and at least one other energy collector element assembled, for example fixed, on the second housing part.

4. The infrared detector according to claim 2, comprising a fixing element adapted to fix the at least one energy collector element to the housing, for example a groove formed in said housing.

5. The infrared detector according to claim 2, wherein at least one of the at least one second face is oriented at an angle relative to the first face, said angle being greater than 0° and less than 180°.

6. The infrared detector according to claim 1, wherein the at least one energy collector in the form of a panel is positioned at a distance from the housing, and the at least one side face is offset from the at least one second face of the housing.

7. The infrared detector according to claim 6, comprising a support structure adapted to position the at least one energy collector in the form of a panel at a distance from the at least one second face of the housing, said support structure being secured to said housing, the support structure having a frustoconical shape, the at least one infrared sensor being mounted either on or in the first face of the housing, or on or in a base of said support structure.

8. The infrared detector according to claim 7, wherein the support structure comprises fixing tabs adapted to receive and hold the at least one energy collector in the form of a panel.

9. The infrared detector according to claim 6, wherein the housing has a substantially parallelepiped shape, for example cubic, or a substantially cylindrical shape, for example circular cylindrical.

10. The infrared detector according to claim 6, wherein the at least one energy collector in the form of a panel surrounds the housing at 360 degrees.

11. The infrared detector according to claim 1, wherein the at least one energy collector in the form of a panel is oriented so as to optimize light capture, for example so as to optimize the angle of incidence of light rays on said at least one energy collector in the form of a panel.

12. The infrared detector according to claim 1, wherein the truncated cone is a truncated circular cone or a truncated pyramidal cone.

13. The infrared detector according to claim 1, wherein the housing further comprises:
a processing unit positioned in the housing and connected to the at least one infrared sensor;
a wireless communication unit positioned in the housing and connected to the processing unit; and/or
an energy storage unit positioned in the housing and connected to the at least one energy collector in the form of a panel; and/or
a wireless communication antenna for example mounted on the first face.

14. The infrared detector according to claim 1, wherein the at least one energy collector in the form of a panel has a single energy collector element, for example in the form of a flexible film; or several energy collector elements assembled to each other in series and/or in parallel.

15. The infrared detector according to claim 1, wherein the at least one energy collector in the form of a panel comprises, for example consists of, at least one photovoltaic panel.
